(19) United States
(12) Patent Application Publication
(10) Pub. No.: US 2026/0018924 A1
(43) Pub. Date: Jan. 15, 2026

(54) CONTROL DEVICE FOR CHARGING SYSTEM

(71) Applicant: TOYOTA JIDOSHA KABUSHIKI KAISHA, Toyota-shi (JP)

(72) Inventor: Yukinori MURAKAMI, Toyota-shi (JP)

(21) Appl. No.: 19/248,704

(22) Filed: Jun. 25, 2025

(30) Foreign Application Priority Data
Jul. 12, 2024 (JP) 2024-112183

(51) Int. Cl. H02J 7/35; H02J 7/00; H02J 7/34

(52) U.S. Cl. CPC H02J 7/35; H02J 7/0048; H02J 7/00712; H02J 7/342; H02J 2207/20; H02J 2300/24

(57) ABSTRACT

A control device performs a first supply process of controlling a voltage converter to supply power from a solar panel to a high-voltage battery via the voltage converter while setting input-output power of a low-voltage battery to zero on the condition that a supplied power value is determined to be equal to or more than a specified power value. The control device performs a second supply process of controlling the voltage converter to supply power from the solar panel and the low-voltage battery to the high-voltage battery via the voltage converter on the condition that the supplied power value is determined to be less than the specified power value. The control device sets the specified power value based on one or more of a first index value indicating the degree of deterioration of the low-voltage battery and a second index value indicating whether the low-voltage battery is likely to deteriorate.

### CROSS-REFERENCE TO RELATED APPLICATION

This application claims priority to Japanese Patent Application No. 2024-112183 filed on Jul. 12, 2024, incorporated herein by reference in its entirety.

### BACKGROUND

### 1. Technical Field

The present disclosure relates to a control device for a charging system.

### 2. Description of Related Art

A vehicle of Japanese Unexamined Patent Application Publication No. 2021-083248 (JP 2021-083248 A) includes a solar panel, a high-voltage battery, a low-voltage battery, an electric motor, an auxiliary device, a DC-DC converter, and a control device. The solar panel generates electric power by being irradiated with sunlight. The high-voltage battery is charged by receiving electric power from the solar panel. The high-voltage battery is a secondary battery for supplying electric power to the electric motor that is a driving source of the vehicle. The low-voltage battery is charged by receiving electric power from the solar panel. The low-voltage battery is a secondary battery for supplying electric power to the auxiliary device. The rated voltage of the low-voltage battery is lower than the rated voltage of the high-voltage battery. The DC-DC converter is configured to convert the voltage of the electric power from the solar panel and output the resultant electric power.

The control device controls the DC-DC converter to supply the electric power from the solar panel to the high-voltage battery, the low-voltage battery, and the auxiliary device. Specifically, the control device determines whether the supplied power value from the solar panel is equal to or larger than a specified power value determined in advance. Then, the control device supplies the electric power from the solar panel to the auxiliary device or the low-voltage battery under the condition that the supplied power value from the solar panel is smaller than the specified power value. The control device supplies the electric power from the solar panel to the high-voltage battery as well as the auxiliary device and the low-voltage battery under the condition that the supplied power value from the solar panel is equal to or larger than the specified power value.

### SUMMARY

In a charging system as in JP 2021-083248 A, it is conceivable to supply electric power from the low-voltage battery to the high-voltage battery via the DC-DC converter. In this case, for example, it is conceivable to make selection as to whether to supply the electric power from the low-voltage battery to the high-voltage battery depending on the magnitude of the supplied power value from the solar panel. When a fixed value is set as a criterion for determination on the magnitude of the supplied power value of the solar panel, however, it is not always possible, depending on the state of the low-voltage battery etc., to make selection as to whether to supply the electric power from the low-voltage battery to the high-voltage battery.

A control device for a charging system for solving the above problem is directed to a charging system including:
a solar panel configured to generate electric power by being irradiated with sunlight;
a low-voltage battery chargeable by receiving the electric power from the solar panel;
a voltage converter configured to step up electric power from the solar panel and the low-voltage battery and output the electric power; and
a high-voltage battery chargeable by receiving the electric power from the voltage converter.

The control device for the charging system is configured to:
acquire a supplied power value from the solar panel;
determine whether the acquired supplied power value is equal to or larger than a specified power value;
perform a first supply process for controlling the voltage converter to supply the electric power from the solar panel to the high-voltage battery via the voltage converter while setting input-output power of the low-voltage battery to zero under a condition that the supplied power value is determined to be equal to or larger than the specified power value;
perform a second supply process for controlling the voltage converter to supply the electric power from the solar panel and the low-voltage battery to the high-voltage battery via the voltage converter under a condition that the supplied power value is determined to be smaller than the specified power value; and
set the specified power value based on one or more of a first index value indicating a degree of deterioration of the low-voltage battery and a second index value indicating a degree of whether the low-voltage battery is in a state in which the low-voltage battery is likely to deteriorate.

With the above configuration, it is possible to increase the probability that the selection as to whether to output the electric power from the low-voltage battery is suitably made based on the state related to the deterioration of the low-voltage battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is a flowchart illustrating power generation control;

FIG. 3 is a flow chart showing setting control; and

FIG. 4 is an explanatory diagram illustrating a flow of electric power in a vehicle.

### DETAILED DESCRIPTION OF EMBODIMENTS

### Schematic Configuration of Vehicle

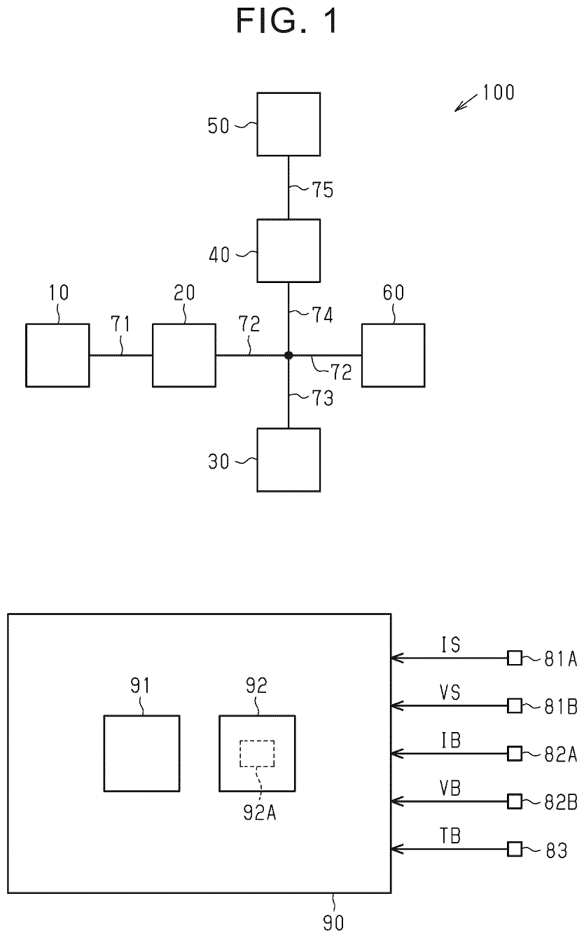

Hereinafter, an embodiment of the present disclosure will be described with reference to FIGS. 1 to 4. First, a schematic configuration of a vehicle 100 to which a charging system is applied will be described.

As illustrated in FIG. 1, the vehicle 100 includes a solar panel 10, a solar converter 20, a low-voltage battery 30, a bidirectional converter 40, a high-voltage battery 50, and an auxiliary device group 60. The vehicle 100 includes a first power line 71, a second power line 72, a third power line 73, a fourth power line 74, and a fifth power line 75.

The solar panel 10 is formed by arranging a plurality of solar cells that generate electric power by being irradiated with sunlight into a panel shape. Therefore, the solar panel 10 generates electric power by being irradiated with sunlight. In the present embodiment, the solar panel 10 is attached to the roof of the vehicle 100.

A first end of the first power line 71 is connected to the solar panel 10. A second end of the first power line 71 is connected to the solar converter 20. Therefore, the solar converter 20 is electrically connected to the solar panel 10.

The solar converter 20 is a device that converts DC power input from the solar panel 10 into a voltage and outputs the voltage. Therefore, the solar converter 20 can convert the electric power from the solar panel 10 into a voltage and output the voltage. The solar converter 20 may step down or step up the power generated by the solar panel 10.

A first end of the second power line 72 is connected to the solar converter 20. A second end of the second power line 72 is connected to the auxiliary device group 60. Therefore, the auxiliary device group 60 is electrically connected to the solar converter 20.

The auxiliary device group 60 includes a plurality of auxiliary devices. Examples of the auxiliary device include an electric oil pump, a navigation system, a display device, an acoustic device, an air conditioner, a lighting device such as a headlight, and various sensors. The auxiliary device group 60 receives power supply via the second power line 72.

The first end of the third power line 73 is connected to the middle of the second power line 72. A second end of the third power line 73 is connected to the low-voltage battery 30. Therefore, the low-voltage battery 30 is electrically connected to the solar converter 20 or the like.

The low-voltage battery 30 is a secondary battery. The low-voltage battery 30 can be charged by receiving electric power from the solar panel 10 via the solar converter 20. The low-voltage battery 30 is a battery for supplying electric power to the auxiliary device group 60. An exemplary rated voltage of the low-voltage battery 30 is about 12 V to 48 V.

The first end of the fourth power line 74 is connected to the middle of the second power line 72. A second end of the fourth power line 74 is connected to the bidirectional converter 40. Therefore, the bidirectional converter 40 is electrically connected to the solar converter 20 or the like. A first end of the fifth power line 75 is connected to the bidirectional converter 40. A second end of the fifth power line 75 is connected to the high-voltage battery 50. Therefore, the high-voltage battery 50 is electrically connected to the bidirectional converter 40.

The high-voltage battery 50 is a secondary battery. The high-voltage battery 50 can be charged by receiving electric power from the bidirectional converter 40. The high-voltage battery 50 is a battery for supplying electric power to an electric motor as a driving source of the vehicle 100 (not shown). The rated voltage of the high-voltage battery 50 is higher than the rated voltage of the low-voltage battery 30. An exemplary rated voltage of the high-voltage battery 50 is about 250 V from 200 V.

The bidirectional converter 40 is a device that converts the DC power input to the bidirectional converter 40 into a voltage and outputs the voltage. The bidirectional converter 40 is a device capable of switching the supply direction of power. Therefore, the bidirectional converter 40 can boost the power input to the bidirectional converter 40 via the fourth power line 74 and supply the boosted power to the high-voltage battery 50. That is, the bidirectional converter 40 can boost the power input to the bidirectional converter 40 from one or more of the solar converter 20 and the low-voltage battery 30 and supply the boosted power to the high-voltage battery 50. Further, the bidirectional converter 40 can step down the electric power input from the high-voltage battery 50 to the bidirectional converter 40 via the fifth power line 75 and supply the electric power to one or more of the low-voltage battery 30 and the auxiliary device group 60. In the present embodiment, the bidirectional converter 40 is an example of a voltage converter capable of boosting and outputting electric power from the solar panel 10 and the low-voltage battery 30.

As illustrated in FIG. 1, the vehicle 100 includes a first current sensor 81A, a first voltage sensor 81B, a second current sensor 82A, a second voltage sensor 82B, and a temperature sensor 83. The first current sensor 81A detects a first current IS, which is a current outputted from the solar converter 20. The first voltage sensor 81B detects a first voltage VS, which is a voltage outputted from the solar converter 20. The second current sensor 82A detects a second current IB, which is a current input to and output from the low-voltage battery 30. In the present embodiment, when a current is outputted from the low-voltage battery 30, the second current IB becomes positive. On the other hand, when a current is inputted to the low-voltage battery 30, the second current IB becomes negative. The second voltage sensor 82B detects a second voltage VB which is a voltage between terminals of the low-voltage battery 30. The temperature sensor 83 detects a battery temperature TB which is the temperature of the low-voltage battery 30.

The vehicle 100 includes a control device 90. The control device 90 acquires various types of information from the first current sensor 81A, the first voltage sensor 81B, the second current sensor 82A, the second voltage sensor 82B, and the temperature sensor 83.

The control device 90 includes an execution device 91 and a storage device 92. An exemplary execution device 91 is a CPU. The storage device 92 includes ROM that can only be read, volatile RAM that can be read and written, and non-volatile storages that can be read and written. The storage device 92 stores various programs and various data in advance. Specifically, the storage device 92 stores the control program 92A in advance as one of various programs. The execution device 91 executes a control program 92A stored in the storage device 92 to execute various processes described later.

The execution device 91 of the control device 90 can control the solar converter 20, the bidirectional converter 40, the auxiliary device group 60, and the like by outputting a control signal to the solar converter 20, the bidirectional converter 40, the auxiliary device group 60, and the like.

### Power Generation Control

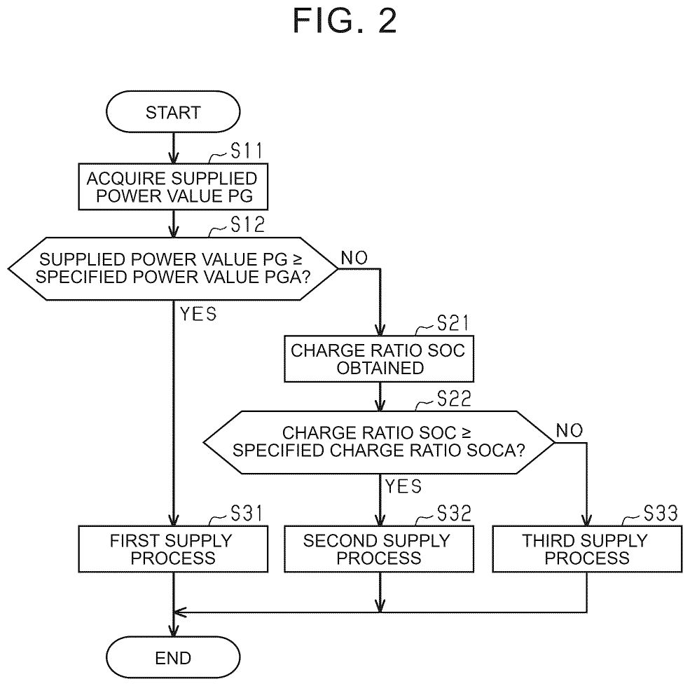

Next, the power generation control executed by the control device 90 will be described with reference to FIG. 2. The power generation control is a control for supplying the electric power generated by the solar panel 10 to each unit. In the present embodiment, the execution device 91 of the control device 90 starts the power generation control at every predetermined control cycle on condition that the solar panel 10 is generating power.

As illustrated in FIG. 2, when the power generation control is started, the execution device 91 of the control device 90 executes S11 process. In S11, the execution device 91 acquires the supplied power value PG supplied from the solar panel 10. Specifically, the execution device 91 obtains the supplied power value PG by calculating the supplied power value PG based on the first current IS and the first voltage VS. Therefore, in the present embodiment, the supplied power value PG is a value of the power supplied from the solar converter 20 to the second power line 72. Note that the supplied power value PG varies depending on, for example, sunlight applied to the solar panel 10. After S11, the execution device 91 advances the process to S12.

In S12, the execution device 91 determines whether or not the supplied power value PG is equal to or greater than a predetermined specified power value PGA. In the present embodiment, the bidirectional converter 40 tends to have a higher conversion efficiency, which is the ratio of the output power to the input power of the bidirectional converter 40, as the input power of the bidirectional converter 40 increases. Therefore, an allowable lower limit value is predetermined as the conversion efficiency of the bidirectional converter 40. The specified power value PGA is defined as the threshold of the supplied power value PG required for realizing the above-described lower limit or more for the bidirectional converter 40. Specifically, the specified power value PGA is determined by setting control described later. The conversion efficiency of the bidirectional converter 40 is a value obtained by dividing the output power of the bidirectional converter 40 by the input power of the bidirectional converter 40. In S12, when the execution device 91 determines that the supplied power value PG is equal to or larger than the specified power value PGA (S12: YES), the execution device 91 advances the process to S31. In other words, the execution device 91 advances the process to S31 on the assumption that it is determined that the supplied power value PG is equal to or larger than the specified power value PGA.

In S31, the execution device 91 executes the first supplying process. Specifically, as indicated by a solid arrow in FIG. 4, the execution device 91 controls the bidirectional converter 40 so as to supply power from the solar panel 10 to the high-voltage battery 50 via the bidirectional converter 40 while setting the input-output power of the low-voltage battery 30 to zero. At this time, the execution device 91 controls the bidirectional converter 40 so as to set the second current IB detected by the second current sensor 82A to zero when the input-output power of the low-voltage battery 30 is set to zero. As illustrated in FIG. 2, after S31, the execution device 91 ends the current power generation control.

On the other hand, in S12 described above, when the execution device 91 determines that the supplied power value PG is less than the specified power value PGA (S12: NO), the execution device 91 advances the process to S21.

In S21, the execution device 91 acquires the charge ratio SOC of the low-voltage battery 30. Specifically, the execution device 91 obtains the charge ratio SOC of the low-voltage battery 30 by calculating the charge ratio SOC of the low-voltage battery 30 based on the second current IB, the second voltage VB, and the battery temperature TB. The charge ratio SOC of the low-voltage battery 30 is expressed by the following Expression (1).

Equation (1): Charge ratio SOC [%]=remaining capacity of low-voltage battery 30 [Ah]/battery capacity of low-voltage battery 30 [Ah]×100 [%]

After S21, the execution device 91 advances the process to S22.

In S22, the execution device 91 determines whether or not the charge ratio SOC of the low-voltage battery 30 is equal to or greater than a predetermined specified charge ratio SOCA. Here, the specified charge ratio SOCA is a threshold for determining whether or not the charge ratio SOC of the low-voltage battery 30 is high to such an extent that electric power can be supplied from the low-voltage battery 30 to the high-voltage battery 50. Note that an exemplary specified charge ratio SOCA is about 60%. In S22, when the execution device 91 determines that the charge ratio SOC of the low-voltage battery 30 is equal to or higher than the specified charge ratio SOCA (S22: YES), the execution device 91 advances the process to S32. In other words, the execution device 91 determines that the supplied power value PG is less than the specified power value PGA and determines that the charge ratio SOC of the low-voltage battery 30 is equal to or higher than the specified charge ratio SOCA, and advances the process to S32.

In S32, the execution device 91 executes the second supplying process. Specifically, as indicated by the alternate long and short dash arrows in FIG. 4, the execution device 91 controls the bidirectional converter 40 to supply electric power from the solar panel 10 and the low-voltage battery 30 to the high-voltage battery 50 via the bidirectional converter 40. At this time, when outputting electric power from the low-voltage battery 30, the execution device 91 controls the bidirectional converter 40 so that the second current IB detected by the second current sensor 82A is positive. As illustrated in FIG. 2, after S32, the execution device 91 ends the current power generation control.

On the other hand, in S22 described above, when the execution device 91 determines that the charge ratio SOC of the low-voltage battery 30 is less than the specified charge ratio SOCA (S22: NO), the execution device 91 advances the process to S33. In other words, the execution device 91 determines that the supplied power value PG is less than the specified power value PGA and determines that the charge ratio SOC of the low-voltage battery 30 is less than the specified charge ratio SOCA, and advances the process to S33.

In S33, the execution device 91 executes the third supplying process. Specifically, as indicated by a broken line arrow in FIG. 4, the execution device 91 controls the bidirectional converter 40 so as to supply the power from the solar panel 10 to the low-voltage battery 30 while setting the input-output power of the high-voltage battery 50 to zero. At this time, the execution device 91 stops the operation of the bidirectional converter 40 when the input-output power of the high-voltage battery 50 is set to zero. As illustrated in FIG. 2, after S33, the execution device 91 ends the current power generation control.

### Setting Control

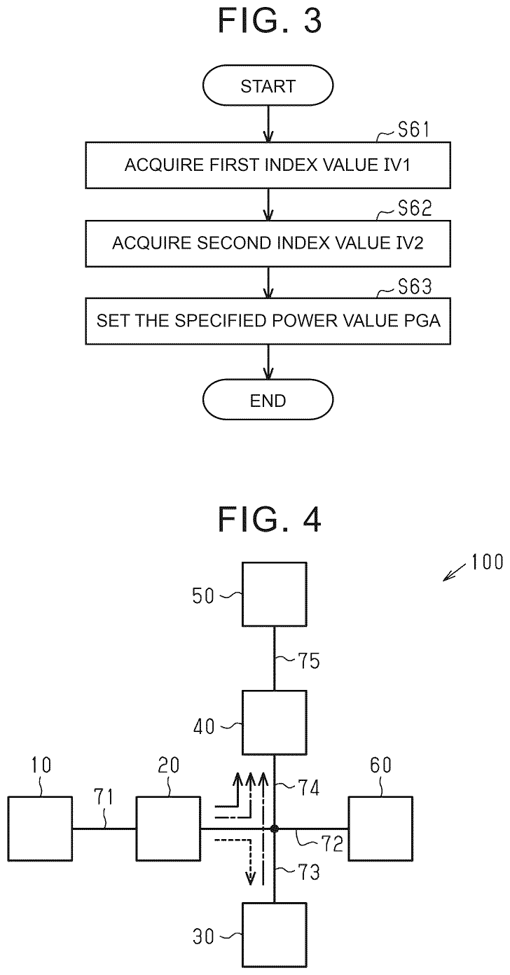

Next, setting control executed by the control device 90 will be described with reference to FIG. 3. This setting control is a control for setting the specified power value PGA. In the present embodiment, the execution device 91 of the control device 90 starts setting control for each predetermined control cycle.

As illustrated in FIG. 3, when the setting control is started, the execution device 91 of the control device 90 executes S61 process. In S61, the execution device 91 acquires the first index value IV1 indicating the degree of degradation of the low-voltage battery 30. Here, the value of the first index value IV1 increases as the degree of degradation of the low-voltage battery 30 increases. In the present embodiment, the execution device 91 obtains the first index value IV1 by calculating the first index value IV1 based on the battery capacity of the low-voltage battery 30 and the history of use of the low-voltage battery 30. Specifically, the execution device 91 calculates the battery capacity of the low-voltage battery 30 based on the second current IB, the second voltage VB, and the battery temperature TB. Then, the execution device 91 calculates a larger value as the first index value IV1 as the cell capacity of the low-voltage battery 30 decreases. In addition, the execution device 91 acquires, as a history of use of the low-voltage battery 30, the number of times that the second supply process of S32 is executed in the power generation control from the manufacturing time point of the low-voltage battery 30 to the processing time point of S61. Further, the execution device 91 acquires, as a history of use of the low-voltage battery 30, the number of times the third supplying process of S33 is executed in the power generation control from the manufacturing time point of the low-voltage battery 30 to the processing time point of S61. Then, the execution device 91 calculates a larger value as the first index value IV1 as the number of times of execution of the acquired second supply processing increases and the number of times of execution of the acquired third supply processing increases. After S61, the execution device 91 advances the process to S62.

In S62, the execution device 91 acquires the second index value IV2 indicating the degree of whether or not the state in which the low-voltage battery 30 is placed is a state in which degradation is likely to occur. Here, the value of the second index value IV2 is larger as the state in which the low-voltage battery 30 is placed is more likely to be deteriorated. In the present embodiment, the execution device 91 obtains the second index value IV2 by calculating the second index value IV2 based on the battery temperature TB. Specifically, the execution device 91 calculates a larger value as the second index value IV2 as the battery temperature TB at the time of S62 process deviates from the predetermined appropriate temperature range. It should be noted that the appropriate temperature range is defined as a range of a temperature that is preferable as an environment in which the low-voltage battery 30 is used. After S62, the execution device 91 advances the process to S63.

In S63, the execution device 91 sets the specified power value PGA based on the first index value IV1 and the second index value IV2. Specifically, the execution device 91 sets a smaller value as the specified power value PGA as the first index value IV1 increases and the second index value IV2 increases. In other words, when the first index value IVI is the first value, the execution device 91 sets a smaller value as the specified power value PGA than the second value indicating that the degree of degradation of the low-voltage battery 30 is smaller than the first value. When the second index value IV2 is the first value, the execution device 91 sets a smaller value as the specified power value PGA than when the second value indicates that the low-voltage battery 30 is less likely to deteriorate than the first value. After S63, the execution device 91 ends the current setting control.

### Operation of Present Embodiment

As illustrated in FIG. 3, in S61 of the setting control, the execution device 91 of the control device 90 acquires the first index value IV1 indicating the degree of degradation of the low-voltage battery 30. In S62, the execution device 91 acquires the second index value IV2 indicating the degree of whether or not the state in which the low-voltage battery 30 is placed is a state in which degradation is likely to occur. In S63, the execution device 91 sets the specified power value PGA based on the first index value IV1 and the second index value IV2.

### Effects of Present Embodiment

(1) According to the present embodiment, the specified power value PGA is set based on the first index value IV1 and the second index value IV2. For example, as the specified power value PGA set in the setting control decreases, an affirmative determination is more likely to be made S12 the power generation control, as shown in FIG. 2. Therefore, the case of execution of the first supply process of S31 and the case of execution of the second supply process of S32 and the third supply process of S33 can be adjusted according to the first index value IV1 and the second index value IV2. Here, in the first supplying process of S31, the execution device 91 supplies the power from the solar panel 10 to the high-voltage battery 50 via the bidirectional converter 40 while setting the input-output power of the low-voltage battery 30 to zero, as indicated by the solid-line arrow in FIG. 4. Therefore, in the first supplying process of S31, electric power is not input and output to and from the low-voltage battery 30. On the other hand, in the second supplying process of S32, the execution device 91 supplies the electric power from the solar panel 10 and the low-voltage battery 30 to the high-voltage battery 50 via the bidirectional converter 40, as indicated by the alternate-chain arrow in FIG. 4. Further, in the third supplying process of S33, the execution device 91 supplies the power from the solar panel 10 to the low-voltage battery 30 while setting the input-output power of the high-voltage battery 50 to zero, as indicated by the broken line arrow in FIG. 4. Therefore, in the second supply process of S32 and the third supply process of S33, electric power is input and output to and from the low-voltage battery 30. Therefore, according to the present embodiment, the case of input and output of electric power to and from the low-voltage battery 30 can be adjusted according to the first index value IV1 and the second index value IV2. In other words, it is possible to increase the probability that selection as to whether or not power is output from the low-voltage battery 30 is suitably performed in accordance with the state of deterioration of the low-voltage battery 30.
(2) As illustrated in FIG. 2, the execution device 91 determines that the supplied power value PG is less than the specified power value PGA, and executes the second supply process of S32 as a requirement that the charge ratio SOC of the low-voltage battery 30 is determined to be equal to or greater than the specified charge ratio SOCA. Further, the execution device 91 determines that the supplied power value PG is less than the specified power value PGA, and executes the third supply process of S33 as a requirement that the charge ratio SOC of the low-voltage battery 30 is determined to be less than the specified charge ratio SOCA. As described above, according to the present embodiment, the specified power value PGA is set based on the first index value IV1 and the second index value IV2. Therefore, it is possible to adjust not only the second supply process of S32 but also the case of executing the third supply process of S33. Accordingly, it is possible to increase the probability that the selection of the presence or absence of the input/output of electric power to/from the low-voltage battery 30 is suitably performed in accordance with the state related to the deterioration of the low-voltage battery 30.
(3) In the vehicles 100, as the number of times S32 second supplying process is executed increases, the degree of degradation of the low-voltage battery 30 tends to increase. Further, as the number of times the third supplying process of S33 is executed increases, the degree of degradation of the low-voltage battery 30 tends to increase.

In this regard, in S61, the execution device 91 acquires the number of times the second supplying process of S32 is executed in acquiring the first index value IV1 indicating the degree of degradation of the low-voltage battery 30. Further, the execution device 91 acquires the number of times the third supplying process of S33 has been executed. Then, the execution device 91 calculates a larger value as the first index value IV1 as the number of times of execution of the acquired second supply processing increases and the number of times of execution of the acquired third supply processing increases. Accordingly, the first index value IV1 can be obtained based on a value closely related to the degree of degradation of the low-voltage battery 30.
(4) In S63, when the first index value IV1 is the first value, the execution device 91 sets a smaller value as the specified power value PGA as compared with a second value indicating that the degree of degradation of the low-voltage battery 30 is smaller than the first value. Therefore, when the degree of deterioration of the low-voltage battery 30 is large, the specified power value PGA is smaller than when the degree of deterioration of the low-voltage battery 30 is small. Accordingly, when the degree of deterioration of the low-voltage battery 30 is large, in other words, when it is difficult to tolerate further deterioration of the low-voltage battery 30, the specified power value PGA can be reduced. When the specified power value PGA is reduced as described above, the second supply process of S32 and the third supply process of S33 are less likely to be executed than when the specified power value PGA is large. As a result, deterioration of the low-voltage battery 30 caused by input and output of electric power to and from the low-voltage battery 30 can be suppressed.
(5) In S63, when the second index value IV2 is the first value, the execution device 91 sets a smaller value as the specified power value PGA than when the second value indicates that the low-voltage battery 30 is less likely to deteriorate than the first value. Therefore, when the low-voltage battery 30 is likely to deteriorate, the specified power value PGA is smaller than when the low-voltage battery 30 is less likely to deteriorate. Accordingly, when the low-voltage battery 30 is easily deteriorated, in other words, the specified power value PGA can be reduced in a situation where the low-voltage battery 30 is to be suppressed from being loaded.

### Modifications

The present embodiment can be realized with the following modifications. The present embodiment and the following modifications can be combined with each other within a technically consistent range to be realized.

In the above embodiment, the power generation control may be changed.

For example, in S11, the manner of acquiring the supplied power value PG may be changed. As a specific example, the execution device 91 may acquire, as the supplied power value PG, the value of the power supplied from the solar panel 10 to the solar converter 20 via the first power line 71.

For example, in S31, the control configuration for setting the input-output power of the low-voltage battery 30 to zero may be changed. As a specific example, the execution device 91 first acquires the power supplied from the solar converter 20 to the second power line 72, the power from the second power line 72 to the high-voltage battery 50, and the power from the second power line 72 to the auxiliary device group 60. Subsequently, the execution device 91 estimates the input-output power of the low-voltage battery 30 on the basis of the acquired three electric powers. Then, the execution device 91 may control the bidirectional converter 40 so as to set the estimated input-output power of the low-voltage battery 30 to zero.

For example, in S32, the control configuration for outputting electric power from the low-voltage battery 30 may be changed. As a specific example, the execution device 91 first acquires the power supplied from the solar converter 20 to the second power line 72, the power from the second power line 72 to the high-voltage battery 50, and the power from the second power line 72 to the auxiliary device group 60. Subsequently, the execution device 91 estimates the input-output power of the low-voltage battery 30 on the basis of the acquired three electric powers. Then, the execution device 91 may control the bidirectional converter 40 to output power from the low-voltage battery 30 based on the estimated input-output power of the low-voltage battery 30.

For example, the third supply process in S33 may be omitted. As a specific example, if power is supplied to the low-voltage battery 30 by a control other than the power generation control, the third supply process in S33 can be omitted. In this case, when the execution device 91 determines in S12 that the supplied power value PG is less than the specified power value PGA (S12: NO), the execution device 91 may proceed the process to S32.

In the above embodiment, the setting control may be changed.

For example, in S61, a method of acquiring the first index value IV1 may be changed. As a specific example, the execution device 91 may acquire the first index value IV1 by calculating the first index value IV1 based on only one of the battery capacity of the low-voltage battery 30 and the history of use of the low-voltage battery 30. In addition, as a specific example, the execution device 91 may acquire the first index value IV1 by calculating the first index value IV1 based on the battery capacity of the low-voltage battery 30 and the history of use of the low-voltage battery 30 instead of or in addition to another value. It should be noted that the above-described another exemplary value is the total number of times of input and output of electric power to and from the low-voltage battery 30 from the time of manufacturing the low-voltage battery 30 to the time of S61 process, and the history of input and output of electric current to and from the low-voltage battery 30. Further, the above-described another exemplary value is a history of the inter-terminal voltage of the low-voltage battery 30 and a history of the battery temperature TB from the manufacturing time of the low-voltage battery 30 to the time of S61 process. An exemplary value of the above-described another value is an internal resistance of the low-voltage battery 30 at the time of S61 process.

For example, in S62, a method of acquiring the second index value IV2 may be changed. As a specific example, the execution device 91 may acquire the second index value IV2 by calculating the second index value IV2 on the basis of another value instead of or in addition to the battery temperature TB. It should be noted that the other exemplary values are the inter-terminal voltage of the low-voltage battery 30, the charge ratio SOC of the low-voltage battery 30, and the ambient temperature of the low-voltage battery 30 at the time of S62 process.

For example, in S63, the method of setting the specified power value PGA may be changed. As a specific example, when the first index value IV1 is equal to or greater than the predetermined first reference value, the execution device 91 may reduce the specified power value PGA as compared with a case where the first index value is less than the first reference value. In addition, as a specific example, the execution device 91 may reduce the specified power value PGA as compared with a case where the second index value IV2 is equal to or greater than a predetermined second reference value and is less than the second reference value. Further, as a specific example, the execution device 91 may set the specified power value PGA based on only one of the first index value IV1 and the second index value IV2. In addition, as a specific example, the execution device 91 may set the specified power value PGA based on another value in addition to one or more of the first index value IV1 and the second index value IV2.

In the above embodiment, the configuration of the vehicle 100 may be changed.

For example, the configuration of the control device 90 may be changed. Specifically, the control device 90 may be configured as a circuitry including one or more processors that execute various processes in accordance with a computer program (software). Note that the control device 90 may be configured as a circuit including one or more dedicated hardware circuits, such as an application-specific integrated circuit (ASIC), or a combination thereof, for executing at least some of the various processes. The processor includes a CPU and a memory such as a random access memory (RAM) and a ROM. The memory stores a program code or an instruction configured to execute the CPU to perform processes. Memory or computer-readable media includes any medium that can be accessed by a general purpose or special purpose computer.

In the above-described embodiment, the charging system is not limited to the vehicle 100 and may be applied. For example, the charging system may be applied to a device. a building, or the like other than the vehicle 100.

What is claimed is:

1. A control device for a charging system including:
a solar panel configured to generate electric power by being irradiated with sunlight;
a low-voltage battery chargeable by receiving the electric power from the solar panel;
a voltage converter configured to step up electric power from the solar panel and the low-voltage battery and output the electric power; and
a high-voltage battery chargeable by receiving the electric power from the voltage converter, wherein
the control device is configured to:
acquire a supplied power value from the solar panel;
determine whether the acquired supplied power value is equal to or larger than a specified power value;
perform a first supply process for controlling the voltage converter to supply the electric power from the solar panel to the high-voltage battery via the voltage converter while setting input-output power of the low-voltage battery to zero under a condition that the supplied power value is determined to be equal to or larger than the specified power value;
perform a second supply process for controlling the voltage converter to supply the electric power from the solar panel and the low-voltage battery to the high-voltage battery via the voltage converter under a condition that the supplied power value is determined to be smaller than the specified power value; and
set the specified power value based on one or more of a first index value indicating a degree of deterioration of the low-voltage battery and a second index value indicating a degree of whether the low-voltage battery is in a state in which the low-voltage battery is likely to deteriorate.

2. The control device for the charging system according to claim 1, wherein the control device is configured to:
acquire a charge ratio of the low-voltage battery;
determine whether the acquired charge ratio is equal to or larger than a specified charge ratio determined in advance;
perform the second supply process for controlling the voltage converter to supply the electric power from the solar panel and the low-voltage battery to the high-voltage battery via the voltage converter under a condition that the supplied power value is determined to be smaller than the specified power value and the charge ratio is determined to be equal to or larger than the specified charge ratio; and
perform a third supply process for controlling the voltage converter to supply the electric power from the solar panel to the low-voltage battery while setting input-output power of the high-voltage battery to zero under a condition that the supplied power value is determined to be smaller than the specified power value and the charge ratio is determined to be smaller than the specified charge ratio.

3. The control device for the charging system according to claim 2, wherein the control device is configured to, when acquiring the first index value, calculate the first index value based on the number of times the second supply process is performed and the number of times the third supply process is performed.

4. The control device for the charging system according to claim 1, wherein the control device is configured to, when the first index value is a first value, set a smaller value as the specified power value compared with a case where the first index value is a second value indicating a smaller degree of deterioration of the low-voltage battery than the first value.

5. The control device for the charging system according to claim 1, wherein the control device is configured to, when the second index value is a first value, set a smaller value as the specified power value compared with a case where the second index value is a second value indicating that the low-voltage battery is in a state in which the low-voltage battery is less likely to deteriorate than the first value.
